(19) United States
(12) Patent Application Publication
(10) Pub. No.: US 2026/0206697 A1
(43) Pub. Date: Jul. 23, 2026

(54) A METHOD FOR PROCESSING WOOD AND A CONTROL SYSTEM FOR CONTROLLING THE OPERATION OF THE HARVESTER HEAD OF A FOREST WORK MACHINE

(71) Applicant: Ponsse Oyj, Vieremä (FI)

(72) Inventor: Jari ÅLANDER, Vieremä (FI)

(21) Appl. No.: 19/144,357

(22) PCT Filed: Dec. 21, 2023
(86) PCT No.: PCT/FI2023/050726

§ 371 Date: Jun. 27, 2025

(30) Foreign Application Priority Data
Dec. 29, 2022 (FI) 20226175

(51) Int. Cl. A01G 23/089; A01G 23/083

(52) U.S. Cl. CPC A01G 23/089; A01G 23/083

(57) ABSTRACT

A method for processing wood by a harvester head (10) of a forest work machine (1), in which method, cross-cutting the trunk of a felled tree (9) into parts by a cross-cutting device (16) of the harvester head, which comprises at least one moving cross-cutting knife (17a, 17b). In the method, determining the thickness of the tree trunk and controlling, to cross-cut the tree, based on the thickness of the tree trunk determined, at least one moving cross-cutting knife into a standby position which differs from the home position of the cross-cutting knife. Additionally, a control system for controlling the operation of the harvester head of a forest work machine and a harvester head.

WO

### BACKGROUND OF THE INVENTION

The invention relates to wood harvesting and particularly to a method, a control system and a harvester head for cross-cutting a tree processed by the harvester head into parts.

When harvesting wood by a harvester, wood is processed by the harvester head of the harvester. Said wood processing typically comprises felling of the tree, removing branches from the felled tree i.e. delimbing, and cross-cutting the trunk of the felled tree into parts of desired length. For delimbing the felled tree and for cross-cutting the tree, the felled tree is fed by means of feeding means of a feeding device of the harvester head through the harvester head and, at the same time, for delimbing the tree trunk, delimbing means of a delimbing device used for removing the branches are pressed against the tree trunk being fed through the harvester head. After this, the section of the tree trunk fed through the harvester head of which branches have been removed is cross-cut into a part of desired length.

The processing of wood by the harvester head of the harvester can also comprise removing bark from the surface of the tree. Typically, the bark is removed from the trunk by means of the combined effect of the feeding device and moving debarking/delimbing blades and fixed debarking means arranged in the body of the harvester head. Often for removing the bark, the felled tree must be fed several times through the harvester head, removing the bark and possible branches from the tree but without cross-cutting the tree being processed into parts.

Some cross-cutting devices used in the harvester head may comprise e.g. one or two moving knives, whereby said knife or said knives, when moving, apply to the tree trunk a compression-or scissors-type cutting effect for cross-cutting the tree trunk. An advantage of a cross-cutting device comprising a knife or knives compared with a cross-cutting device equipped with a chain-saw-type cross-cutting saw is its lower operating and maintenance costs. The operating and maintenance costs of the cross-cutting device equipped with a cross-cutting saw are increased by e.g. lubrication that the cross-cutting saw substantially continuously requires as well as chain and saw flange replacements. A problem of the cross-cutting device comprising said knife or said knives compared with the cross-cutting device equipped with the chain-saw-type cross-cutting saw is still the slower operating speed of the cross-cutting device, due to which, the hourly production capacity of the harvester head equipped with said type of cross-cutting device is commonly smaller than that of the cross-cutting device equipped with the cross-cutting saw.

### BRIEF DESCRIPTION OF THE INVENTION

It is the object of the invention to provide a new type of a method for processing wood, a new type of a control system for controlling the operation of the harvester head of a forest machine and a new type of a harvester head of a forest machine.

The solution according to the invention is characterised by what is disclosed in the independent claims.

In the solution according to the invention, the thickness of the trunk of a felled tree is determined and, based on the determined thickness of the tree trunk, at least one moving cross-cutting knife of the cross-cutting device of the harvester head is controlled, to cross-cut the tree, into a standby position which differs from the home position of the cross-cutting knife.

Due to the solution according to the invention, when the intention is to cross-cut the trunk of the felled tree into parts by the cross-cutting device of the harvester head comprising at least one moving knife, the at least one moving cross-cutting knife of the cross-cutting device may be controlled into a position differing from the home position of the cross-cutting knife to wait for the coming cross-cutting measure of the tree trunk. In other words, due to the solution according to the invention, the cross-cutting knife may be controlled into such a position where the cross-cutting knife, for the coming cross-cutting measure of the tree trunk, is closer to the tree trunk to be cross-cut compared with its home position already before the feeding of the tree is stopped in the harvester head for the cross-cutting of the tree. Said at least one moving cross-cutting knife may thus already be controlled closer to the tree for the cross-cutting of the tree, either during the feeding of the tree already before the tree stops for cross-cutting or even immediately after the cross-cutting measure performed before continuing the feeding of the tree in the harvester head for the next cross-cutting measure, whereby said at least one moving cross-cutting knife can be controlled to a standby position differing from its home position without returning said cross-cutting knife to its home position between successive cross-cutting measures. This makes the tree cross-cutting stage faster and thus increases the production capacity of the harvester head equipped with cross-cutting knives without increasing energy consumption used for the production, and even decreases the energy consumption used for the production, because there is no need to return the cross-cutting knife into its home position after each cross-cutting measure in order to continue feeding the tree in the harvester head.

Some embodiments of the invention are presented in the dependent claims.

### BRIEF DESCRIPTION OF THE DRAWINGS

The invention will now be described in greater detail by means of preferred embodiments and with reference to the attached drawings, in which

FIG. 1 is a schematic view of a harvester,

FIG. 2 is a schematic view of a harvester head of a harvester, turned into a substantially horizontal position,

FIG. 3 is a schematic view of the harvester head of FIG. 2, turned into a substantially vertical position,

FIG. 4 is a schematic view of the harvester head of FIG. 2, as seen from behind and partially opened,

FIG. 5 is a schematic view of a control method for controlling the operation of a cross-cutting device of a harvester head for cross-cutting a felled tree processed by harvester head into parts, and

FIGS. 6a-6d are schematic views, a harvester head seen from the rear, of the use of a cross-cutting device of the harvester head for cross-cutting a tree.

For reasons of clarity, some embodiments of the invention are illustrated in the figures in a simplified form. In the figures, like reference numerals identify like elements.

### DETAILED DESCRIPTION OF THE INVENTION

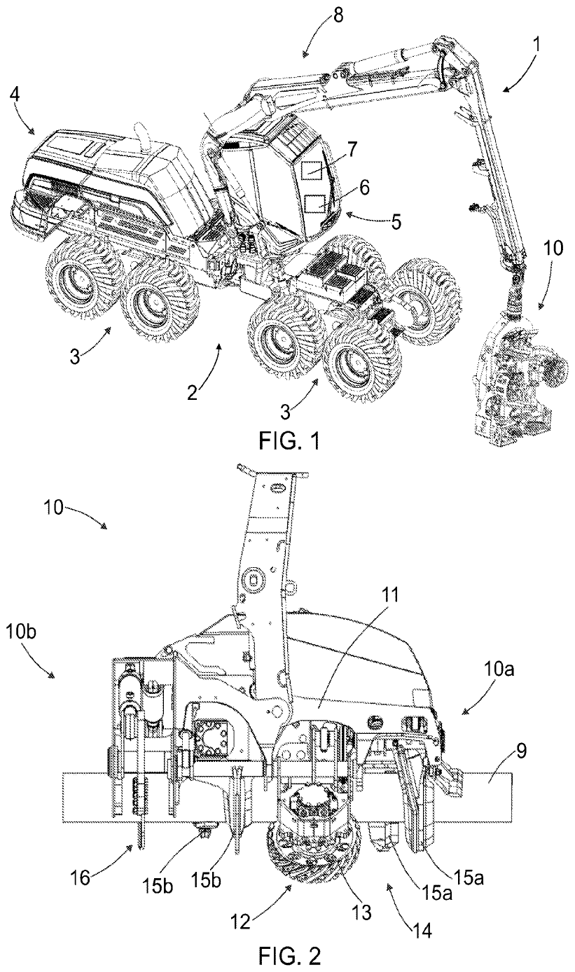

FIG. 1 is a schematic view of a harvester 1 in which the above-described arrangement can be applied. The harvester 1 comprises a chassis 2, which constitutes at least part of the frame structure of the harvester 1 and into connection with which are arranged moving means 3, by means of which, the harvester 1 may move in relation to its work surface or work environment. Said moving means 3 are wheels in FIG. 1, but generally said moving means can comprise at least one of the following: wheels arranged on an axle, wheels arranged on a bogie, a track system or some other means known as such to provide the movement of the harvester and to possibly change the direction of the movement of the harvester in relation to its work surface or work environment. Said moving means can further comprise one or more braking devices for decelerating the driving speed of the harvester 1 or for stopping the drive of the harvester totally.

The harvester 1 further comprises a power source 4. The power source 4 can comprise e.g. a combustion engine, one or more electric motors and sets of batteries, and/or a generator or different combinations of these for generating the required power for providing the movement of the harvester, for increasing its movement speed and for operating the devices arranged in the harvester.

The harvester 1 additionally comprises a cab 5. The cab 5 may be arranged foldably and/or rotatably in relation to the chassis 2. The cab 5 comprises required control means 6, by means of which, the operator of the harvester may control the drive of the harvester and the devices arranged to it. Said control means 6 are shown very schematically in FIG. 1 and they may comprise e.g. one or more manually controllable control means, such as e.g. a control lever, and/or one or more foot-controllable control means, such as e.g. a pedal. Said control means 6 can also comprise a pre-designed harvester work plan in the form of a runnable programme which is runnable by e.g. one or more harvester control units 7 very schematically shown in FIG. 1 for controlling the drive of the harvester and the devices arranged in it. Said control unit 7 can be e.g. a computer or some other device or means comprising a microprocessor or some other microcontroller that is obvious to those skilled in the art.

The harvester 1 further comprises a boom 8. The boom 8 can be supported e.g. on the chassis 2 or a separate tilting base or some other part of the harvester frame or a part connected to the frame. The boom 8 may be arranged foldably and/or rotatably in relation to the chassis 2. The outmost end of the boom 8 includes a harvester head 10 of the harvester 1. The outmost end of the boom 8 and the harvester head 10 arranged to it constitute a tip of the boom 8.

The harvester 1 of FIG. 1 constitutes a moving forest machine equipped with a harvester head, which is intended for performing felling of trees, removing branches and/or bark from the felled tree and cross-cutting the trunk of the felled tree into parts of desired length. Alternatively, the moving forest machine equipped with a harvester head may also be a combination of a forwarder and a harvester, whereby the forest machine in question also comprises a load space for taking a load, typically parts of the tree trunk cross-cut to size, to be transported by the forest machine. Furthermore, the moving forest machine equipped with a harvester head may also be some other forest machine suitable for felling trees and/or processing felled trees, such as e.g. a digger with a harvester head fixed to its boom.

The forest machines of FIG. 1 are typically forest machines operating based on the active control of the operator of the forest machine. However, it is also possible to apply the here presented solution in both semi-autonomously operating forest machines, whereby the forest machine can operate without the active control of the operator at least for some time, and in a substantially totally autonomously operating forest machine, whereby the operator does not actively contribute to the control of the forest machine operations without a special reason. In connection with said both semi-autonomously operating forest machine and totally autonomously operating forest machine, the means used for controlling the forest machine can be located separate from the forest machine, whereby the forest machine does not necessarily comprise an actual cab and the control of the forest machine is implemented by remote control or automatically.

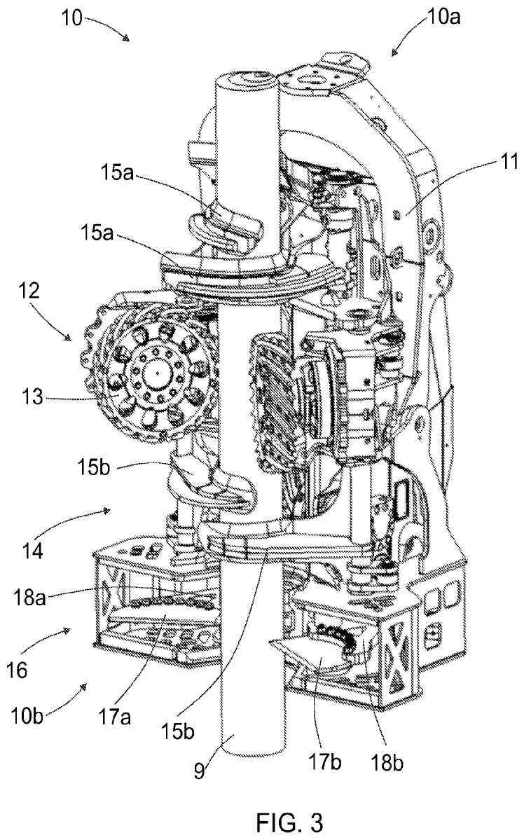

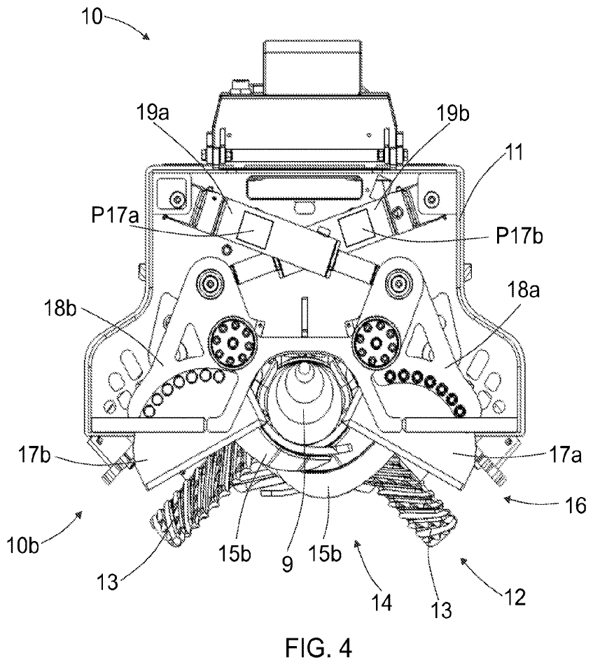

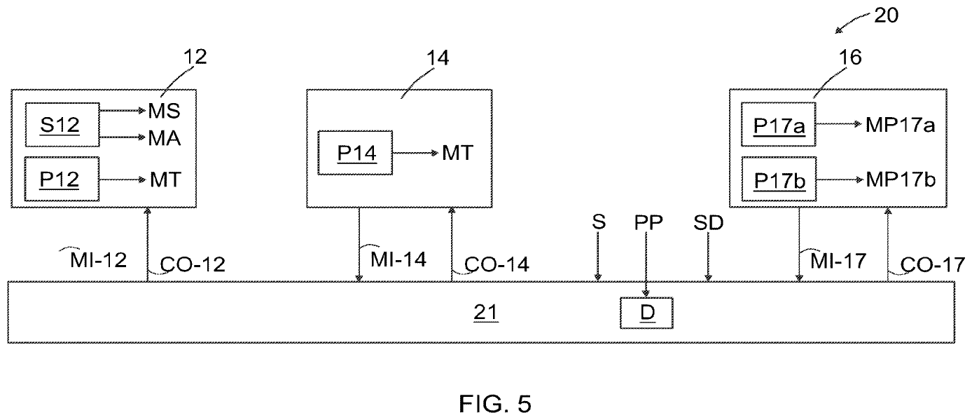

FIG. 2 schematically shows a harvester head 10 of the harvester turned in a substantially horizontal position, i.e. a position where the harvester head 10 typically is when processing a felled tree by the harvester head. FIG. 3 schematically shows the harvester head 10 of FIG. 2 turned in a substantially vertical position, i.e. a position where the harvester head 10 is when felling a tree. FIG. 4 schematically shows the harvester head 10 of FIG. 2, as seen from the rear and partially opened. FIGS. 2, 3 and 4 also schematically show a part of the trunk of a tree 9 being processed by the harvester head 10 supported by the harvester head 10, for clarity without branches and without showing the tree in its original length.

When the felled tree is processed in the harvester head, the felled tree is fed either in one direction or back and forth in the harvester head, and branches and/or bark is removed from the tree trunk, and the tree trunk is cross-cut into at least two parts separate from each other such that at least the crown of the tree is separated from the other part of the tree trunk. The harvester head 10 of FIGS. 2, 3 and 4 is applicable for performing felling of the tree, removing branches and/or bark from the felled tree, and cross-cutting the trunk of the felled tree into parts of desired length. However, the here presented solution is also applicable in such a harvester head which is only applicable for removing branches and/or bark from a felled tree and the cross-cutting of the tree trunk in question, or solely for the cross-cutting of an already delimbed and/or debarked tree trunk and which harvester heads are also sometimes called processing heads of a forest machine to separate them from harvester heads also suitable for tree felling.

The harvester head 10 of FIGS. 2-4 comprises a frame structure 11, into connection with which, means intended for the felling of the tree and the processing of the felled tree fitted to the harvester head 10 are arranged. The means intended for the felling and processing of the tree typically comprise a feeding device 12, a delimbing device 14 and a cross-cutting device 16, wherein the feeding device 12 is used for supporting the tree during its felling and for feeding the tree through the harvester head 10 when processing the felled tree in the harvester head 10, the delimbing device 14 is used for supporting the tree during its felling and for removing the branches of the felled tree i.e. for delimbing the tree being fed through the harvester head 10 by the feeding device 12, and the cross-cutting device 16 is used for cross-cutting the tree being felled and for cross-cutting the trunk of the tree 9 being fed through the harvester head 10 by the feeding device 12 into parts of desired length.

The feeding means of the feeding device 12 and the delimbing means of the delimbing device 14 may also be used for debarking the tree i.e. removing the bark from the surface of the tree. Often for removing the bark, the felled tree must be fed several times through the harvester head 10, removing the bark and possible branches from the tree but without cross-cutting the tree being processed into parts yet. The debarking of the tree takes place from the combined effect of the feeding means of the feeding device 12 applied to the bark of the tree and the delimbing means of the delimbing device 14 as well as fixed debarking means arranged to the frame of the harvester head in a way known as such by those skilled in the art. The debarking may also be intensified during the motion of the tree by bringing the tree trunk to a rotating motion around its central axis by means of the feeding device 12, such as by a suitable surface pattern of feeding rolls forming possible feeding means of the feeding device 12.

Typically, the feeding device 12, the delimbing device 14 and the cross-cutting device 16 are hydraulically operated devices, comprising actuators operating by means of substantially incompressible fluid pressure medium for controlling the operation of the feeding means of the feeding device 12, the delimbing means of the delimbing device 14 and the cross-cutting means of the cross-cutting device 16 by affecting the pressure and/or flow direction of pressure medium being fed to said actuators in a way known as such by those skilled in the art. Said actuators may be e.g. various cylinders, valves, motors, or pumps, or some other pressure sources.

The tree 9 being processed by the harvester head 10 is fed by the feeding device 12 forward from the direction of a front part 10a of the harvester head 10 into the direction of a rear part 10b of the harvester head 10. If required, the tree 9 may also be fed backward from the direction of the rear part 10b of the harvester head 10 into the direction of the front part 10a of the harvester head 10. During said feed of the tree 9, branches are removed from the trunk of the tree 9 by the delimbing device 14. The part of the trunk of the tree 9, from which the branches have been removed, is cross-cut into parts of desired length by the cross-cutting device 16 which is arranged to the rear part 10b of the harvester head 10, the cross-cutting device 16 thus being, in the typical travel direction of the tree 9 through the harvester head 10, the latest device which applies processing measures for the part of the harvester head 10 to the tree 9 being fed through the harvester head 10. Before the cross-cutting of the trunk of the tree 9, when the tree 9 is being fed forward through the harvester head 10, it is also possible to debark the trunk of the tree 9. Alternatively, the trunk of the tree 9 may also be fed, after the possible delimbing, by means of the feeding device 12 back and forth through the harvester head 10 in order to debark the tree 9 before cross-cutting the trunk of the tree 9 into parts, as described above.

The feeding device 12 of the harvester head 10 comprises feeding means which are pressed against the tree trunk for both supporting the tree to be felled during the felling and for feeding the felled tree 9 being processed by the harvester head 10 by using said feeding means in the harvester head 10. In the harvester head 10 of FIGS. 2-4, said feeding means comprise feeding rolls 13, which are wheels provided with an outward directed toothing, which are pressed, by using one or more actuators related to them, against the surface of the trunk of the tree 9 and rotated for feeding the tree 9 being processed through the harvester head 10. Instead of feeding rolls 12, the feeding means may be e.g. continuous feeding belts or chains of the chain track type.

The delimbing device 14 of the harvester head 10 comprises delimbing means which are pressed against the tree trunk for both supporting the tree to be felled during the felling and for delimbing the felled tree 9 being processed by the harvester head 10 when the felled tree 9 is being fed through the harvester head 10 by the feeding device 12. In the harvester head 10 of FIGS. 2-4, said delimbing means comprise front delimbing knives 15a located in the direction of the front part 10a of the harvester head 10 in relation to the feeding rolls 13, that is, the front delimbing knives 15a located in front of the feeding rolls 13 seen in the typical feeding direction of the tree 9, and rear delimbing knives 15b located in the direction of the rear part 10b of the harvester head 10 in relation to the feeding rolls 13, that is, the rear delimbing knives 15b located behind the feeding rolls 13 seen in the feeding direction of the tree 9. The front and rear delimbing knives 15a, 15b are pressed by using one or more actuators related to them against the trunk of the tree 9 in order to cut the branches from the tree 9 being fed through the harvester head 10, and possibly also to debark the tree as presented above, whereby said front and/or rear delimbing knives 15a, 15b constitute combined moving debarking and delimbing knives. In addition to said movable front and/or rear delimbing knives 15a, 15b, the harvester head may also include fixed knives intended for removing branches and/or bark.

The cross-cutting device 16 of the harvester head 10 comprises cross-cutting means by which the tree being felled is cross-cut at the desired point and cross-cut into parts of desired length when the felled tree 9 is fed by the feeding device 12 through the harvester head 10. In the cross-cutting device 16 of FIGS. 2-4, the cross-cutting means comprise two moving cross-cutting knives 17a, 17b, that is, a first cross-cutting knife 17a and a second cross-cutting knife 17, which are pressed by moving in the direction of each other through the trunk of the tree 9 being between the knives in order to cross-cut the tree 9. The cross-cutting knives 17a, 17b are fastened to corresponding knife holders 18a, 18b, that is, the first cross-cutting knife 17a to the corresponding first knife holder 18a, and the second cross-cutting knife 17b to the corresponding second knife holder 18b, whereby, by moving said knife holders 18a, 18b, the cross-cutting knives 17a, 17b may be moved into the direction of each other and back away from each other. Said fastening may be e.g. a bolt and nut fastening, whereby worn knives 17a, 17b are easily replaceable by new ones. The cross-cutting device 16 further comprises a first actuating cylinder 19a connected to the first knife holder 18a and a second actuating cylinder 19b connected to the second knife holder 18b, whereby said first actuating cylinder 19a is configured via the first knife holder 18a, that is by affecting the position or attitude of the first knife holder 18a, to move the first cross-cutting knife 17a towards the tree 9 being felled and through it, or away from it, and correspondingly the second actuating cylinder 19b is configured via the second knife holder 18b, that is by affecting the position or attitude of the second knife holder 18b, to move the second cross-cutting knife 17b towards the tree 9 being felled and through it, or away from it.

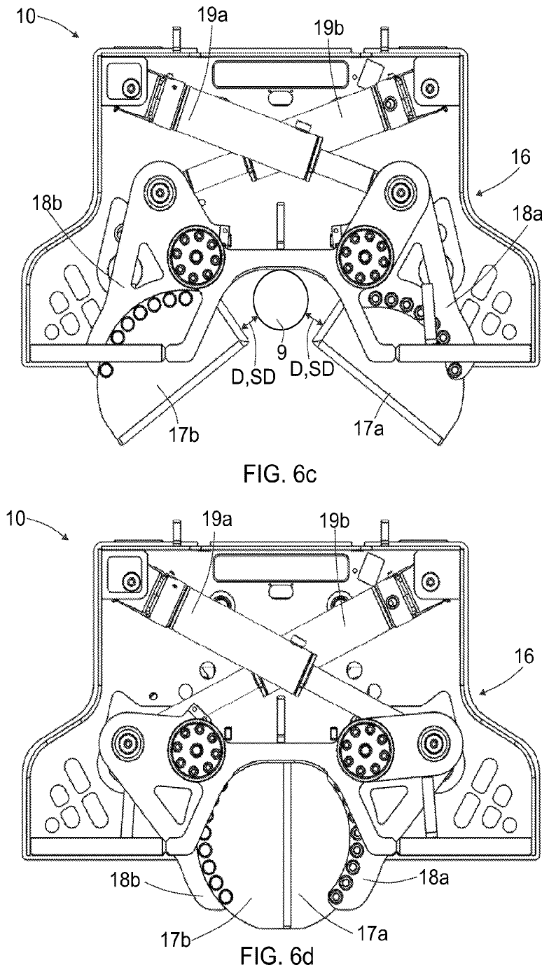

The cross-cutting knives 17a, 17b of FIGS. 2-4 implement, as shown below in FIGS. 6a-6d, the cross-cutting of the tree by cutting such that, at the end stage of the cross-cutting, the cross-cutting knives 17a, 17b end up slightly over-lapping in relation to each other. Alternatively, the two moving cross-cutting knives could implement the cross-cutting of the tree of the scissors-type, whereby the cross-cutting knives go crosswise in relation to each other during the cross-cutting. The cross-cutting device equipped with two moving cross-cutting knives could also implement the cross-cutting of the tree of the press cutting type, whereby the cross-cutting knives 17a, 17b end up against each other in the end stage of the cross-cutting.

As an alternative to the embodiment of Figures, the cross-cutting device 16 may comprise only one moving cross-cutting knife. By means of said only one moving cross-cutting knife, the cross-cutting of the tree may be implemented both by the scissors-type solution, whereby the cross-cutting knife goes past an edge formed by a counter piece in the end stage of the cross-cutting, and by the press-cutting-type solution, whereby the cross-cutting knife ends up against a fixed counter piece in the end stage of the cross-cutting.

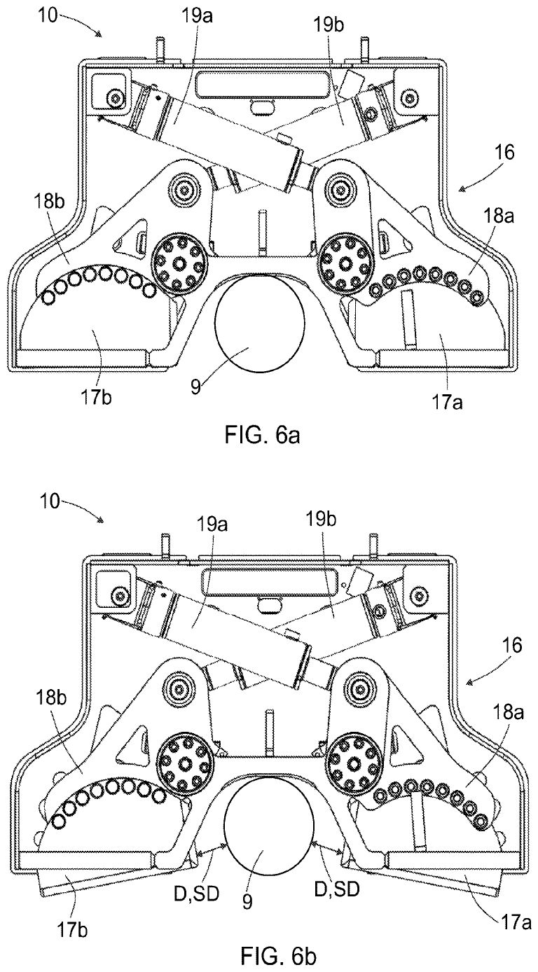

FIG. 5 schematically shows a control system 20 for controlling the operation of the harvester head 10 for processing the tree 9. The control system 20 of FIG. 5 comprises a control unit 21 which is configured, in accordance with this description, to particularly control the operation of the cross-cutting device 16 but it may also control the operation of the feeding device 12 and/or the delimbing device 14. The control unit 21 of the harvester head 10 may be implemented as a part of the control unit 7 of the harvester 1 or it may be a control unit physically separate from the control unit 7 of the harvester 1 but functionally configured to work together with the control unit 7 of the harvester 1.

In the solution presented here, the control system 20 is particularly configured to control at least one moving cross-cutting knife of the cross-cutting device 16 of the harvester head 10 for cross-cutting the tree 9 into parts such that the control system 20 is configured to determine a thickness MT of the trunk of the tree 9 being processed and to control, in order to cross-cut the tree 9, based on the determined thickness MT of the trunk of the tree 9 at least one cross-cutting knife to a standby position, which can also be called the standby position of the cross-cutting knife and which standby position or attitude differs from the home position of the cross-cutting knife, in which position or attitude the cross-cutting knife is when the cross-cutting knife 17a, 17b is not used. In said home position, the cross-cutting knife 17a, 17b is typically in such extreme position or attitude wherein the cross-cutting knife 17a, 17b is as far away as possible from the trunk of the tree 9 going through the harvester head 10 or at least inside a casing possibly arranged for the cross-cutting knife 17a, 17b.

With particular reference to FIGS. 2-5, in accordance with the solution, based on the determined thickness MT of the trunk of the tree 9, at least one cross-cutting knife 17a, 17b is controlled during the processing of the tree 9, that is, when the harvester head 10 has grabbed the felled tree 9 in order to process it by the harvester head 10, to such a standby position which differs from the home position of the cross-cutting knife 17a, 17b. Then, the feeding of the tree 9 having stopped for the cross-cutting of the tree 9, the cross-cutting knife 17a, 17b is thus already closer to the tree 9 being fed through the harvester head 10 for cross-cutting the trunk of the tree 9 than when being in its home position. In accordance with the solution, when processing the tree 9 by the harvester head 10, the position of at least one cross-cutting knife 17a, 17b is thus deflected from its home position such that the cross-cutting knife 17a, 17b in advance transfers to such a standby position for the cross-cutting of the tree 9 where the cross-cutting knife 17a, 17b is closer to the trunk of the tree 9 compared with its home position for cross-cutting the tree 9 when the feeding of the tree 9 forward through the harvester head 10 stops for the cross-cutting of the tree 9. The controlling of the cross-cutting knife 17a, 17b to the above standby position may comprise e.g. the control of the cross-cutting knife 17a, 17b at a predetermined constant distance SD from the surface of the trunk of the tree 9 when the position of the cross-cutting knife 17a, 17b in its home position and the determined thickness MT of the trunk of the tree 9 are known. Alternatively, as described in more detail below, the controlling of the cross-cutting knife 17a, 17b to the above standby position may comprise the control of the cross-cutting knife 17a, 17b at a distance D determined in some other way based on the determined thickness MT of the tree trunk from the surface of the trunk of the tree 9 when the position of the cross-cutting knife 17a, 17b in its home position and the determined thickness MT of the trunk of the tree 9 are known.

When, in accordance with the solution, said at least one cross-cutting knife 17a, 17b is controlled away from said home position towards the tree 9 being fed through the harvester head 10 before the feeding of the tree 9 is stopped for the cross-cutting of the tree 9, the cross-cutting stage of the tree 9 may be made faster and thus increase the production capacity of the harvester head 10 equipped with at least one cross-cutting knife without increasing energy consumption used for the production, and even decreases the energy consumption used for the production, because there is also no need to return the cross-cutting knife 17a, 17b into its home position after each cross-cutting measure in order to continue feeding the tree 9 through the harvester head 10. Said at least one moving cross-cutting knife may be controlled beforehand closer to the tree for the cross-cutting of the tree during the feeding of the tree before the tree stops for the cross-cutting. Alternatively said at least one moving cross-cutting knife may be controlled beforehand closer to the tree for the cross-cutting of the tree, immediately after the cross-cutting measure done before continuing the feeding of the tree in the harvester head for the next cross-cutting measure, whereby said at least one moving cross-cutting knife can be controlled to the standby position differing from its home position without returning said cross-cutting knife to its home position between successive cross-cutting measures.

A control unit 21 of the control system 20 of FIG. 5 is configured in accordance with the solution to particularly control the operation of the cross-cutting device 16 i.e. the cross-cutting knives 17a, 17b by means of a control connection CO-17. Furthermore, the control unit 21 may be configured to control the operation of the feeding device 12 by means of a control connection CO-12 and the operation of the delimbing device 14 by means of a control connection CO-14. Data describing the operation of the feeding device 12, the delimbing device 14 and the cross-cutting device 16 or measurements performed in each of them may be transferred to the control unit 21 by means of corresponding data transfer connections MI-12, MI-14 and MI-17.

The control unit 21 may be e.g. a computer or some other device or means comprising a microprocessor or some other micro controller, obvious to the those skilled in the art, which is configured to perform via a programme stored in the control unit 21, based on measurement data received by the control unit 21 and/or data further determined based on them, control measures particularly affecting the operation of the cross-cutting knives 17a, 17b of the cross-cutting device 16, but possibly also control measures affecting the operation of the feeding device 12 and the delimbing device 14. In practice, said control measures performed the control unit 21 provide, in a way known as such by those skilled in the art, a required change in the operation of the feeding device 12, the delimbing device 14 and/or the cross-cutting device 16 as a response to a change in the pressure and/or volume flow and/or flow direction of pressure medium related to each other them, being fed to one or more actuators.

According to an embodiment, the control system 20 comprises at least one sensor P12 arranged in the feeding device 12 and/or at least one sensor P14 arranged in the delimbing device 14 which sensor is configured to determine the thickness MT of the trunk of the tree 9 being fed through the harvester head 10 by determining the position of the feeding means of the feeding device 12 and/or the delimbing means of the delimbing device 14, said feeding means and/or delimbing means being pressed against the trunk of the tree 9. The thickness data MT of the trunk of the tree 9 being processed are transferred to the control unit 21 of the harvester head 10 which control unit, based on said thickness data MT, controls the at least one cross-cutting knife 17a, 17b of the cross-cutting device 16 to a position differing from its home position closer to the trunk of the tree 9 for cross-cutting the tree 9 when the feeding of the tree 9 is stopped for the cross-cutting of the tree 9. In the feeding device 12, said at least one sensor P12 is thus configured to determine the thickness MT of the tree trunk at the point of the feeding rolls 13. In the delimbing device 14, said at least one sensor P14 is thus configured to determine the thickness MT of the tree trunk at the point of the front delimbing knives 15a and/or the rear delimbing knives 15b.

After having cross-cut the trunk of the tree 9, in order to continue the feeding of the tree 9 forward through the harvester head 10, the cross-cutting knife 17a, 17b may be transferred backward towards the home position e.g. to a standby position corresponding the just performed cross-cutting measure, or such a position which is somewhat more towards the home position compared with the standby position corresponding the just performed cross-cutting but not until the home position. From this position, the cross-cutting knife in question may again be controlled beforehand closer to the tree into a standby position corresponding the next tree cross-cutting measure during the feeding of the tree already before the tree stops for the next cross-cutting measure. Alternatively, the cross-cutting knife in question may be controlled immediately after the already performed cross-cutting measure into a new standby position for the next cross-cutting measure of the tree trunk before the feeding of the tree is continued in the harvester head for the next cross-cutting measure of the tree trunk. As long as the harvester head 10 processes the same tree, there is thus no need for transferring the cross-cutting knife 17a, 17b back to the home position after each cross-cutting measure but only at an adequate distance from the tree 9 such that the tree 9 being fed forward through the harvester head 10 does not hit the cross-cutting knife 17a, 17b.

If the processing of the trunk of the tree 9 by the harvester head 10 is started from the butt end of the tree 9, such as typically occurs when processing the tree 9 by the harvester head 10, as the processing of the tree 9 progresses, the thickness of the trunk of the tree 9 typically substantially stays the same or be-comes smaller. Therefore, according to an embodiment related to the processing of wood, the cross-cutting knife 17a, 17b may be transferred after the cross-cutting of the trunk of the tree 9 back to that standby position of the cross-cutting knife 17a, 17b where the cross-cutting knife 17a, 17b was before the start of the cross-cutting measure performed latest.

According to an embodiment, the control system 20 comprises at least one sensor P17a, P17b arranged to the cross-cutting device 16 for determining the position MP17a, MP17b of at least one cross-cutting knife 17a, 17b e.g. in relation to the home position of the cross-cutting knife 17a, 17b. Said at least one sensor P17a, P17b produces accurate feedback data on the actual position MP17a, MP17b of the cross-cutting knife 17a, 17b for controlling the position of the cross-cutting knife 17a, 17b based on the determined thickness MT of the trunk of the tree 9 such that the tree being fed forward through the harvester head 10 does not hit the cross-cutting knife 17a, 17b.

According to an embodiment, the actuating cylinder 19a, 19b of the knife holder 18a, 18b of the cross-cutting device 16 comprises at least one sensor P17a, P17b for detecting the operational position of the actuating cylinder 19a, 19b and, via the operational position of said actuating cylinder 19a, 19b, the position MP17a, MP17b of the cross-cutting knife 17a, 17b in the cross-cutting device 16 e.g. in relation to the home position of the cross-cutting knife 17a, 17b. Said position of the cross-cutting knife 17a, 17b may be determined e.g. based on pulse data produced by the corresponding sensor P17a, P17b. Said sensors P17a, P17b are also schematically shown in FIG. 4 in connection with the actuating cylinders 19a, 19b.

According to an embodiment, the control system 20 is configured to determine the distance S between said at least one cross-cutting knife 17a, 17b and the measurement point of the thickness of the trunk of the tree 9, to determine the thickness MT of the trunk of the tree being processed substantially continuously, to determine the tree feeding speed MS and/or the tree feeding acceleration MA substantially continuously, and to control the position of said at least one cross-cutting knife 17a, 17b substantially continuously based on the determined thickness MT of the trunk of the tree, distance S between said at least one cross-cutting knife 17a, 17b and the measuring point of the thickness of the trunk of the tree 9 as well as tree feeding speed MS and/or tree feeding acceleration MA.

The distance S between said at least one cross-cutting knife 17a, 17b and the measurement point of the thickness of the trunk of the tree 9 is a harvester head specific constant, whereby the determination of the distance between said at least one cross-cutting knife 17a, 17b and the measurement point of the thickness of the trunk of the tree 9 comprises in practice the setting of said constant distance S as a parameter to the control unit 21.

When determining the thickness of the trunk of the tree 9 being processed substantially continuously, at least one sensor P12 is arranged to the feeding device 12 and/or at least one sensor P14 is arranged to the delimbing device 14 to measure in a way described above the thickness MT of the trunk of the tree 9 being fed forward through the harvester head 10 substantially continuously. The feeding speed MS and/or the feeding acceleration MA of the tree 9 may be determined substantially continuously e.g. by at least one sensor S12 arranged in the feeding device 12, which sensor is configured to measure e.g. the rotation speed and/or acceleration of the feeding rolls 13. The feeding speed MS and/or the feeding acceleration MA of the tree 9 determine the longitudinal offset of the trunk of the tree 9 in relation to the measurement point of the thickness of the trunk of the tree 9 and the cross-cutting knives 17a, 17b of the cross-cutting device 16.

The substantially continuous determination of the thickness of the trunk of the tree 9 and the substantially continuous determination of the feeding speed and/or the feeding acceleration of the tree 9 unambiguously align the specific single determined thickness MT of the trunk of the tree 9 to a specific point of the tree 9 in its longitudinal direction, whereby the position of said at least one cross-cutting knife 17a, 17b substantially continuously based on the determined thickness MT of the trunk of the tree 9, distance S between said at least one cross-cutting knife 17a, 17b and the measuring point of the thickness of the trunk of the tree 9 as well as feeding speed MS and/or feeding acceleration MA of the tree 9.

According to an embodiment, the determined thickness MT of the tree 9 is the thickness of the butt end of the tree 9. As the processing of the trunk of the tree 9 by the harvester head 10 is typically started from the butt end of the tree 9, as the processing of the tree 9 progresses, the thickness of the trunk of the tree 9 typically substantially stays the same or becomes smaller. Then, it is possible to consider that the thickness of the butt end of the tree 9 indicates the largest thickness of the trunk of the tree 9 which may be used as a specific determined thickness MT of the tree trunk for the whole length of the trunk of the tree 9 for controlling the cross-cutting knives 17a, 17b of the cross-cutting device 16 in advance to a standby position closer to the trunk of the tree 9 for cross-cutting the tree 9. Then, the determination of the thickness of the trunk of the tree 9 does not necessarily have to be continuous. However, compared with the above-described continuous determination of the thickness of the tree trunk and the substantially continuous control of the position of at least one cross-cutting knife based on this determination, the increase in the production capacity provided by this embodiment is still smaller because, as the processing of the tree 9 progresses, the thickness of the trunk of the tree 9 typically decreases and the cross-cutting knife 17a, 17b might stay unnecessarily far away from the surface of the trunk of the tree 9 to wait for the cross-cutting to be performed next.

According to an embodiment, the control system 20 is configured to determine a measurement corresponding a predetermined percentage PP of the determined thickness MT of the trunk of the tree 9 and to control, in order to cross-cut the tree 9, said at least one cross-cutting knife 17a, 17b to a standby position, where said cross-cutting knife 17a, 17b is at a distance D substantially corresponding the determined distance from the trunk of the tree 9. Said percentage PP may be e.g. 10-20 percent of the determined thickness MT of the tree. When the cross-cutting knife 17a, 17b is not controlled closer than the distance D corresponding the percentage PP in question to the trunk of the tree 9 for the cross-cutting of the tree 9, it is possible to ensure that the tree 9 being fed through the harvester head 10 does not hit the cross-cutting knife 17a, 17b. At the same time, the cross-cutting knife 17a, 17b may still be controlled to wait for the tree 9 to stop for the cross-cutting considerably closer to the tree 9 than where the cross-cutting knife 17a, 17b would be in its home position, which considerably speeds up the cross-cutting measure of the tree 9 and thus increases the production capacity of the harvester head 10 equipped with at least one moving cross-cutting knife.

According to an embodiment, the above-mentioned percentage PP may also be changing such that said percentage PP is the larger the smaller the measured thickness of the trunk of the tree 9 is.

According to an embodiment, the distance of the cross-cutting knife from the tree in the standby position is determined as described above with a fixed or changing percentage or some other formula based on the diameter of the tree, but said distance is additionally set with a fixed minimum and/or maximum value the closer to the tree 9 or the farther from the tree 9 the cross-cutting knife 17a, 17b will not be controlled for the standby position. These measures can ensure that, also when processing the top of the tree 9, the cross-cutting knives 17a, 17b will not be controlled too close to the trunk of the tree 9 such that the tree 9 being fed forward through the harvester head 10 would hit the cross-cutting knife 17a, 17b being controlled to the standby position, but not either too far away from the tree 9 such that no considerable enhancement of the operation of the cross-cutting device 16 would be achieved.

According to an embodiment, the control system 20 is configured to determine the thickness MT of the trunk of the tree 9 from the butt end of the tree 9 or so close to the butt end of the trunk of the tree 9 as possible by the harvester head 10 being used and an estimate based on said determined thickness MT and a tree species specific trunk graph stored earlier for the tree species being processed on the change in the thickness of the trunk towards the top of the tree. Based on said estimate, the control unit 21 of the control system 20 may determine an estimate for the thickness of the cross-cutting point/points of the trunk of the tree 9 and, based on it, further a distance D, at which distance D the cross-cutting knife 17a, 17b may be controlled into a standby position for the cross-cutting of the trunk of the tree 9.

According to an embodiment, the control system 20 is configured to control said at least one cross-cutting knife 17a, 17b to a home position as a response to feeding the tree backward through the harvester head 10, thus ensuring that the tree 9 being fed backward through the harvester head 10 does not hit the cross-cutting knife 17a, 17b. Alternatively, the cross-cutting knife 17a, 17b may also be controlled e.g. based on the thickness of the butt end of the tree into a determined standby position, or some other standby position which should also be sufficient to prevent the tree being fed backward in the harvester head 10 from hitting the cross-cutting knife 17a, 17b.

When the felled tree 9 has been totally processed by the harvester head 10, said at least one cross-cutting knife 17a, 17b is controlled back to the home position to wait for a tree to be processed next.

FIGS. 6a-6d schematically show, the harvester head 10 seen from the rear, a use of the cross-cutting device 16 of the harvester head 10 for cross-cutting a felled tree. In FIG. 6a, the cross-cutting device 16 is shown in a use situation where the felled tree 9 has been grabbed by the feeding means of the feeding device 12 and/or the delimbing means of the delimbing device 14 and where the cross-cutting knives 17a, 17b of the cross-cutting device 16 are still in their home position. For clarity, the feeding device 12 and the feeding means in it and the delimbing device 14 and the delimbing means in it are not shown in FIGS. 6a-6d.

In FIG. 6b, the cross-cutting device 16 is shown in a use situation where the cross-cutting knives 17a, 17b have been controlled based on the determined thickness MT of the tree 9, for cross-cutting the tree 9, away from their home position towards the trunk of the tree 9 to a standby position differing from the home position for cross-cutting the tree 9. In FIG. 6b, the cross-cutting knives 17a, 17b have thus been somewhat offset from their home position towards the trunk of the tree 9 at a distance from the trunk of the tree 9. Said distance may be the above-mentioned pre-set constant distance SD or e.g. some above-mentioned distance D determined based on the determined thickness MT of the trunk of the tree 9. In a use situation of FIG. 6b, the thickness of the trunk of the tree 9 is still quite large, that is, in the use situation of FIG. 6b, the cross-cutting measure of the tree 9 will be directed close to the butt end of the tree 9.

In FIG. 6c, the cross-cutting device 16 is shown in a use situation where the tree 9 has already been cross-cut such that the thickness of the tree 9 to be cross-cut is already quite small, that is, in the use situation of FIG. 6c, the cross-cutting measure of the tree 9 will be directed clearly closer to the tree top than in FIG. 6b. In the use situation of FIG. 6c, the cross-cutting knives 17a, 17b have thus already been offset for a great deal from their home position towards the trunk of the tree 9 at a distance from the trunk of the tree 9. Said distance may thus be the above-mentioned pre-set constant distance SD or e.g. some above-mentioned distance D determined based on the determined thickness MT of the trunk of the tree 9.

In FIG. 6d, the cross-cutting device 16 is shown in a use situation of the cross-cutting of the tree 9 already performed, where the cross-cutting knives 17a, 17b have ended up slightly overlapping in relation to each other at the end of the cross-cutting of the tree 9.

The embodiment of FIGS. 2-4 and 6a-6d substantially comprises two cross-cutting knives that are substantially of the same shape and size and configured to move substantially mirror image like by their paths. Alternatively, the embodiment comprising two moving cross-cutting knives may also comprise cross-cutting knives different in relation to their size or shape or said path, whereby the standby positions or standby attitudes of the cross-cutting knives differing different from their home position are not symmetrical in relation to the tree 9 before the cross-cutting of the tree 9, or the positions or attitudes of the cross-cutting knives after the cross-cutting of the tree 9 has ended are not symmetrical in relation to the tree 9.

Those skilled in the art will find it obvious that, as technology advances, the basic idea of the invention may be implemented in many different ways. The invention and its embodiments are thus not restricted to the examples described above but can vary within the scope of the claims.

1. A method for processing wood by a harvester head of a forest work machine, in which method
cross-cutting the trunk of a felled tree into parts by a cross-cutting device of the harvester head, which comprises at least one moving cross-cutting knife,
determining the thickness of the tree trunk and
controlling, to cross-cut the tree, based on the thickness of the tree trunk determined, at least one moving cross-cutting knife into a standby position which differs from the home position of the cross-cutting knife.

2. A method according to claim 1, wherein after the cross-cutting of the tree trunk, at least one moving cross-cutting knife is controlled into a standby position which differs from the home position of the cross-cutting knife without returning said cross-cutting knife to its home position.

3. A method according to claim 1,
wherein the felled tree is fed in the harvester head by the feeding device of the harvester head and wherein, before the cross-cutting of the tree trunk, the felled tree is processed in the harvester head in at least one of the following ways: delimbing the tree by the delimbing device of the harvester head, or debarking the tree by the combined effect of the feeding device and the delimbing device directed at the bark of the tree.

4. A method according to claim 1, wherein the cross-cutting device of the harvester head comprises two moving cross-cutting knives, and wherein, to cross-cut the tree, based on the determined thickness of the tree trunk, both of the cross-cutting knives are controlled into a standby position which differs from the home position of the cross-cutting knife.

5. A method according to claim 1, wherein the thickness of the tree trunk is determined by at least one of the following ways: by determining the position of the feeding means of the feeding device said feeding means being pressed against the tree trunk, or by determining the position of the delimbing means of the delimbing device said delimbing means being pressed against the tree trunk.

6. A method according to claim 1, wherein
a distance between said at least one cross-cutting knife and the measurement point of the thickness of the tree trunk is determined,
the thickness of the tree trunk is determined substantially continuously,
the tree feeding speed and/or the tree feeding acceleration is/are determined substantially continuously, and
said at least one cross-cutting knife is controlled substantially continuously based on the determined thickness of the tree trunk, the distance between said at least one cross-cutting knife and the measurement point of the thickness of the tree trunk and the tree feeding speed and/or tree feeding acceleration.

7. A method according to claim 1, wherein said at least one moving cross-cutting knife is controlled to a standby position by controlling said cross-cutting knife at a determined distance from the surface of the tree, which determined distance is one of the following: a preset constant distance, or a distance determined based on at least one thickness of the tree.

8. A control system for controlling the operation of a harvester head of a forest work machine, which harvester head comprises a cross-cutting device equipped with at least one moving cross-cutting knife and which control system is configured to control said cross-cutting device for cross-cutting a felled tree into parts,
to determine the thickness of the tree trunk and
to control, to cross-cut the tree, based on the thickness of the tree trunk determined, at least one cross-cutting knife into a standby position which differs from the home position of the cross-cutting knife.

9. A control system according to claim 8,
wherein the control system is configured to control, after the cross-cutting of the tree trunk, said at least one moving cross-cutting knife into a standby position which differs from the home position of the cross-cutting knife without returning said cross-cutting knife to its home position.

10. A control system according to claim 8,
wherein the harvester head comprises a feeding device and a delimbing device and wherein the control system is configured to control the feeding device for feeding a felled tree in the harvester head and the processing of the felled tree in the harvester head before the cross-cutting of the tree trunk in at least one of the following ways: to control the delimbing device for delimbing the tree, or to control the feeding device and the delimbing device for debarking the tree by the combined effect of the feeding device and the delimbing device directed at the bark of the tree.

11. A control system according to claim 8, wherein the cross-cutting device of the harvester head comprises two moving cross-cutting knives and wherein the control system is configured to control, to cross-cut the tree, based on the determined thickness of the tree trunk, both of the cross-cutting knives into a standby position which differs from the home position of the cross-cutting knife.

12. A control system according to claim 8, wherein the control system comprises at least one of the following:
at least one sensor arranged in the feeding device to determine the thickness of the tree trunk by determining the position of the feeding means of the feeding device said feeding means being pressed against the tree trunk, or at least one sensor arranged in the delimbing device to determine the thickness of the tree trunk by determining the position of the delimbing means of the delimbing device said delimbing means being pressed against the tree trunk.

13. A control system according to claim 8, wherein the control system comprises at least one sensor arranged in the cross-cutting device for determining the position of said at least one cross-cutting knife in relation to its home position.

14. A control system according to claim 13, wherein said sensor is arranged to an actuator used for controlling the position of the cross-cutting knife.

15. A control system according to claim 8, wherein the control system is configured to
determine a distance between said at least one cross-cutting knife and the measurement point of the thickness of the tree trunk,
determine the thickness of the tree substantially continuously,
determine the tree feeding speed and/or the tree feeding acceleration, and
control the position of said at least one cross-cutting knife substantially continuously based on the determined thickness of the tree trunk, the distance between said at least one cross-cutting knife and the measurement point of the thickness of the tree trunk and the tree feeding speed and/or tree feeding acceleration.

16. A control system according to claim 8, wherein the control system is configured to control said at least one moving cross-cutting knife to a standby position by controlling said cross-cutting knife at a determined distance from the surface of the tree, which determined distance is one of the following: a preset constant distance, or a distance determined based on at least one thickness of the tree.

17. A harvester head of a forest work machine, which comprises a cross-cutting device including at least one moving cross-cutting knife for cross-cutting a tree trunk, wherein
the cross-cutting device comprises at least one actuator for changing the position of at least one cross-cutting knife by using said actuator and
at least one sensor arranged to said at least one actuator to indicate the position of said cross-cutting knife in the cross-cutting device for controlling the cross-cutting knife, for cross-cutting the tree trunk, to a standby position which differs from the home position of the cross-cutting knife.

18. A harvester head according to claim 17,
wherein the cross-cutting device comprises two moving cross-cutting knives and wherein the cross-cutting device comprises at least two actuators for changing the position of both cross-cutting knives by at least one actuator corresponding each cross-cutting knife and wherein
the at least one actuator corresponding each cross-cutting knife comprises at least one sensor to indicate the position of said cross-cutting knife in the cross-cutting device for controlling the cross-cutting knife, for cross-cutting the tree trunk, to a standby position which differs from the home position of the cross-cutting knife.

19. A harvester head according to claim 17,
wherein the cross-cutting device comprises a knife holder for fastening the cross-cutting knife to the cross-cutting device and an actuating cylinder connected to the knife holder, which actuating cylinder constitutes an actuator for changing the position of the cross-cutting knife in the cross-cutting device, and wherein said actuating cylinder comprises at least one sensor to indicate the operating position of the actuating cylinder and, via the operating position of said actuating cylinder, the position of the cross-cutting knife in the cross-cutting device.
